(19) United States
(12) Patent Application Publication
(10) Pub. No.: US 2013/0117107 A1
(43) Pub. Date: May 9, 2013

(54) SYSTEM AND METHOD FOR BUILDING ADVERTISEMENTS FROM IMPORTED DATA

(71) Applicant: Jon C. Evans, Sarasota, FL (US)

(72) Inventor: Jon C. Evans, Sarasota, FL (US)

(21) Appl. No.: 13/669,090

(22) Filed: Nov. 5, 2012

Related U.S. Application Data
(60) Provisional application No. 61/556,198, filed on Nov. 5, 2011.
(60) Provisional application No. 61/557,485, filed on Nov. 9, 2011.

(51) Int. Cl. G06Q 30/02

(52) U.S. Cl. CPC G06Q 30/0276
USPC 705/14.53; 705/14.72; 705/14.49; 705/14.61

(57) ABSTRACT

An advertisement creation system and a method are disclosed. The system comprises a processor, a first interface executing on the processor that accepts transactional data, a data compiler executing on the processor that compiles the transactional data and determines an advertisement creation schedule based on the compiled data, an advertisement creator executing on the processor that automatically creates an advertisement based on a set of rules and the compiled transactional data, and an output device to output the advertisement.

### REFERENCE TO RELATED APPLICATIONS

This application claims priority to U.S. Provisional Application No. 61/556,198 filed Nov. 5, 2011 and to U.S. Provisional Application No. 61/557,458 filed Nov. 9, 2011, both of which are entitled “System and Method for Building Advertisements from Imported Data,” and both of which are specifically and entirely incorporated by reference.

### BACKGROUND OF THE INVENTION

1. Field of the Invention

This invention relates to the field of advertisement creation, and more particularly to automatically creating advertisements from imported data.

2. Description of the Background

Important to the sale of any product or service is the control of four basic attributes: the product or service; the places where buyers can find the product or service (or the distribution channels to get the product or service in front of the buyers); the price; and the product or service's promotion (or advertising). These elements are often referred to as the “Four Ps” of marketing and they constitute the marketing mix.

The Product is a tangible object or an intangible service. Every product is subject to a life-cycle including a growth phase followed by an eventual period of decline as the product approaches market saturation. To retain its competitiveness in the market, product differentiation is required and is one of the strategies to distinguish a product from its competitors.

The Price is the amount a seller offers a consumer to purchase a product or service. A business may adjust the price of product in relation to competitors that offer the same product or the product's sales statistics.

The Place (or placement) represents where a product or service can be purchased. It is often referred to as the distribution channel. It can include any physical store as well as virtual stores on the Internet.

Promotion represents all of the communications that a marketer may use in the marketplace. One aspect of promotion is advertising.

It is desirable to quickly and cost effectively create advertisements based on one or more of the Four P's. Furthermore, advertisers keep data related to the Four P's organized in databases. Therefore, it is desirable to have a system that can use the data to quickly and cost effectively create advertisements.

### SUMMARY OF THE INVENTION

The present invention overcomes the problems and disadvantages associated with current strategies and designs and provides new systems and methods of creating advertisements.

One embodiment of the invention is directed to an advertisement creation system. The system comprises a processor, a first advertiser interface executing on the processor that accepts transactional data, a data compiler executing on the processor that processes the transactional data and determines an advertisement creation arrangement, layout, type, delivery method, output method, file type, priority and schedule based on the processed data, an advertisement creator executing on the processor that automatically creates an advertisement based on a set of rules and the compiled transactional data, and an output device to output the advertisement.

Preferably, the first advertiser interface accepts a data file directly into the system or uploaded manually by the advertiser. In a preferred embodiment, a second advertiser interface executing on the processor obtains edits to the advertisement from the advertiser. Preferably, a third advertiser interface executing on the processor presents the advertiser with a preview of the advertisement and accepts a selection of a file type for output. The file output type is preferably one of a print-ready or electronic file, a high-resolution file format, an email, an html file, a website, a link, a SMS or MMS text, a common data file, a POS data file, a report, a graphic, an audio file, or a video file.

Preferably, the file output is automatically formatted for a commercial printer, desktop printer, video player, audio player, social media, mobile technology, Smartphone, Tablet, laptop, website, email, or text message. In a preferred embodiment, the transactional data is uploaded as at least one of an XML file, a CSV file, an Access file, an Excel file, or a POS system file. In a preferred embodiment, the data comprises at least one of an advertisement creation schedule, a product or service to be advertised, promotional event, educational material, title, description, item number, SKU, price, dates of sale, date for advertisement publication, mark-up on price, availability, consumer demand index, velocity, trends, history, consumer information, distribution information, marketing information, educational content, features and benefits, product code, ingredients, lifecycle, expiration date, shelf life, product metrics, cost, suggested retail price, margin, priority ranking of products, advertisement codes, and combinations thereof.

Preferably, the set of rules prioritize the products to be advertised based on business criteria. The business criteria are preferably at least one of sales volume, velocity, price, margin, discount, inventory levels, inventory age, shelf life, product life-cycle, sales history, promotions, rebates, distribution, availability, competition, trends, marketing and combinations thereof. Preferably, the data compiler determines the advertisement creation type, format, target audience, delivery method, output and schedule based on the business criteria reaching a specified time and criteria level.

In a preferred embodiment, a data source is linked to the system for automatic and scheduled advertisement creation. Preferably, the advertiser is notified of a created advertisement through one of an email, system alert, text, or an electronic notification.

Preferably, upon completion, an ad is automatically delivered to an advertiser-specified destination, wherein the advertiser-specified destination is at least one of a commercial printer, email distribution list, website, SMS text recipients, social network, desktop printer, and direct mail service.

In a preferred embodiment, an order interface obtains printing, direct mail services, newspaper insertion, and delivery options. Preferably, the advertisement is automatically posted to or links to websites and social networks for advertising. Preferably, the system automatically updates website keywords for search engine optimization based on the content of an advertisement.

In a preferred embodiment, a single advertisement is automatically created and delivered to a target audience based on purchasing information or product inquiry. Preferably, the single advertisement is delivered to the customer via at least one of email, text message, posted to website, and social media. Preferably, the single advertisement is delivered at a determined time after the product inquiry. In a preferred embodiment, an advertising campaign consisting of multiple advertisements and various formats is created. The completed advertisement data is preferably made available as a data file to export into a POS system, mainframe, or common data program. The advertisement data is preferably compiled and analyzed to create further targeted automated advertisements.

Another embodiment of the invention is directed to a method of creating an advertisement. The method comprises the steps of a computer obtaining transactional data, compiling the transactional data, determining an advertisement creation schedule based on the compiled transactional data, applying the compiled transactional data to a set of rules to determine advertisement content priorities, automatically creating an advertisement based on a set of rules and the compiled transactional data, and outputting the advertisement to an output device.

In a preferred embodiment a data file is manually uploaded directly to the computer by an advertiser. The method preferably further comprises obtaining edits to the advertisement from the advertiser. The method preferably further comprises presenting the advertiser with a preview of the advertisement and accepting a selection of a file type for output. The file output type is preferably one of a print-ready or electronic file, a high-resolution file format, an email, an html file, a website, a link, a SMS or MMS text, a common data file, a POS data file, a report, a graphic, an audio file, or a video file. Preferably, the file output is automatically formatted for a commercial printer, desktop printer, video player, audio player, social media, mobile technology,

Preferably, the transactional data is uploaded as at least one of an XML file, a CSV file, an Access file, an Excel file, or a POS system file. In a preferred embodiment, the data comprises at least one of an advertisement creation schedule, a product or service to be advertised, promotional event, educational material, title, description, item number, SKU, price, dates of sale, date for advertisement publication, mark-up on price, availability, consumer demand index, velocity, trends, history, consumer information, distribution information, marketing information, educational content, features and benefits, product code, ingredients, lifecycle, expiration date, shelf life, product metrics, cost, suggested retail price, margin, priority ranking of products, advertisement codes, and combinations thereof.

Preferably, the advertisement content priorities are based on business criteria. In a preferred embodiment, the business criteria are at least one of sales volume, velocity, price, margin, discount, inventory levels, inventory age, shelf life, product life-cycle, sales history, promotions, rebates, distribution, availability, competition, trends, marketing and combinations thereof. The method preferably further comprises determining the advertisement creation schedule based on the business criteria reaching a specified level.

Preferably, a data source is linked to the system for automatic and scheduled advertisement creation. The method preferably further comprises notifying the advertiser of a created advertisement through one of an email, system alert, text, or an electronic notification. The method preferably further comprises, upon completion, automatically delivering the advertisement to an advertiser-specified destination, wherein the advertiser-specified destination is at least one of a commercial printer, email distribution list, website, SMS text recipients, and direct mail service.

The method preferably further comprises obtaining printing, direct mail services, newspaper insertion, and delivery selections. The method preferably further comprises automatically posting the advertisement to websites for advertising. The method preferably further comprises automatically updating website keywords for search engine optimization based on the content of an advertisement.

Preferably, a single advertisement is automatically created and delivered to a customer based on purchasing information or product inquiry. In a preferred embodiment, the single advertisement is delivered to the customer via at least one of email and text message. Preferably, the single advertisement is delivered at a determined time after the product inquiry. Preferably, the completed advertisement data is made available as a data file to export into a POS system, mainframe, or common data program.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 illustrates an example system embodiment;

FIG. 2 illustrates an example schematic embodiment of the system.

FIG. 3 illustrates another example schematic embodiment of the system.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, a handheld scanning device, or a wireless devices, including wireless Personal Digital Assistants (“PDAs”) (e.g., Palm™ VII, Research in Motion's Blackberry™, an Android™ device, Apple's iPhone™), tablet devices (e.g. Apple's iPad™, etc.) wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, computing devices, projectors, RIPs, speakers, and plotters. In some embodiments, the output can be via a network interface, for example uploading to a website, emailing, attached to or placed within other electronic files, delivering to a third-party such as a commercial printer or direct mail service provider, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the preferred embodiment, an advertiser will receive a preview of an automatically-created customized advertisement through an email message, link, text, or system preview. The preview may be directly delivered, or delivered through an Internet connection, the advertiser may link to website on a host computer. The different programs may be physically hosted together or separately. The web site may, for example, be maintained and hosted by a manufacturer, a supplier, or an Internet Service Provider. The website, when accessed, may request a user to log into the site by entering a username and password to further edit an advertisement, or may provide production or ordering capabilities without logging in. In the preferred embodiment, users who log in will use a User Name and Password. However, in certain embodiments, additional information can be required, for example store number or company identification. The User Name and Password can be an email address or combination of letters, numbers, and/or symbols. Preferably, each User Name is unique. Based on user identification, access to the system can be determined. Furthermore, based on user identification, a user's preferences, accessible databases, and other resources the user has access to, is uploaded.

Many retail operators and corporations utilize a point of sale (POS) system to control sales transactions, inventory, etc., linked to an accounting software system. Data is captured on a transactional basis and stored within a database. In the preferred embodiment, the data can be spread out over multiple tables within the database. There can be one database or multiple linked databases. This data can be extracted and provided in a variety of methods. For example, corporations, retailers, individuals, or other advertisers interested in developing an advertisement can provide a common data source (e.g. XML, CSV, Access, Excel, a POS system export, or another data compiling system), as well as proprietary or mainframe formats. The data files can be uploaded to the advertisement creator's data collection database through an Internet interface, FTP site, direct system interface, web service, or another uploading system. Preferably the data is consumed raw. The data can be exported into an advertisement creation system to create a single advertisement or an advertising campaign, including a circular, flyer(s), email blast, ROP newspaper advertisements, signage, free standing insert (FSI), newsletter, educational materials, coupons, link to a data source, database, report, website post, social media post and SMS text message. The types of advertisements may be directed within the data source, through an interface, through program preferences, or through other human interaction.

The advertisements can be built based on system intelligence, through fields within the data, or through an interface. For example, advertisers my provide direction as to importance, location or arrangement of data components. The advertisers can be individual stores, store chains, manufacturers, suppliers, or combinations thereof. Additionally, the data for the advertisements may be uploaded by one advertiser or multiple advertisers. The system can be connected directly to data sources, such as a POS system, ordering system, mainframe or other data output facility to receive data automatically.

In a preferred embodiment, the system and the method of the present invention may accept user instructions for designing the layout of an advertisement. For example, user may identify one or more priorities that the system may use in creating a preferred layout. Sample priorities may include, for example, maximum size of product image; maximum number of advertised products per page; minimum separation between product references; maximum font or type size; minimum font or type size; predetermined number of product references per page; grouping by manufacturer; and grouping by product category. The system may automatically arrange the products to be advertised based on the priorities. In other embodiments, the system is completely automatic and arranges the advertisements without input from a user.

In another preferred embodiment, the advertiser may order or purchase products from a supplier, manufacturer, or vendor. For example, an order may be placed through an ordering system or may be generated through a POS system. An advertiser's product order can be uploaded to the advertisement creator system to automatically create one or more advertisements for each product ordered, for a subset of the products ordered, or for all of the products ordered. The created advertisements then can be provided to the advertiser for review.

In another preferred embodiment, the user may submit a list of product references to be automatically laid-out by the priority-based layout program. It is contemplated that a user may reset priorities and then preview the results based on the new list of priorities. The priority-based layout system will work especially well when each product being advertised has multiple product references from which the assistance program may choose. For example, if a top priority is maximum product image size, the system may layout the initial draft advertisement using those product references with the largest images. This means that the product references may include information describing the differences between the various product references for each product. For example, a database of product references may be designed to hold up to ten product references for each product, whereby the product references are organized from largest product image to smallest product image. In any case, the priority-based layout system may provide better refinement in circumstances when there are multiple product references for each of the products being advertised.

In another preferred embodiment, the system will utilize product attribute and historical data to automatically prioritize the positioning of items within an advertisement based on a set of rules provided by the advertiser or automatically determined by the system. It is contemplated that transactional data specifying product promotions, velocity, discounts, life-cycle, profit margins, inventory levels, product date, availability, marketing analytics, sales history and other product or industry-related information is available and will be provided by users or by an organization utilizing the invention and providing it to be accessed by a users. Transactional data may also include historical data, third party data, scheduling data, and other data used in the creation of an advertisement. For example, items with a higher profit margin and a higher sales velocity will be more prominently displayed within an advertisement. As another example, a product with a short life cycle coupled with a sales promotion will be placed on the front page of an advertisement. Additionally, individual advertiser's transactional data may be provided in combination with system data to further and more specifically influence prioritization and positioning for that user's advertisements.

The following are several examples of categories of transactional data for evaluating, ordering, and weighting for the prioritization of arranging products into automatically produced custom advertisements:

a) Product promotion (i.e. distributor/manufacturer promotions representing lower retail pricing or greater profit potential). Product promotions reflect suggested items to be purchased or promoted. Promotions also affect retail purchases. Products on promotion may be given a prominent advertising position.

b) Product velocity (i.e. data ordered based on highest to lowest sales volume). Higher velocity products may be given a more prominent advertising position.

c) Product price (i.e. data ordered based on highest to lowest price). Higher priced products at, for example, 30% off represent a greater savings than a low priced item with the same discount and therefore may be given a more prominent advertising position.

d) Product life cycle (i.e. data ordered based on highest to lowest life). For example short life cycle product which are disposable and/or perishable products (e.g. toilet paper, tissues, milk, bottled water, soda, staples, coffee, and fresh vegetables), medium life cycle products (e.g. paint, vitamins, tape, light bulbs, batteries, toothpaste, motor oil, canned products, spices, nails, screws, and glue), or long life cycle products (e.g. power tools, hand tools, appliances, clothing, and furniture).

e) Product profit (i.e. data ordered on highest profit margin). Products with a higher profit margin may be displayed more prominently.

f) Program history (i.e. data gathered over a period of time and analyze for historical purchase, promotion and sales data to influence advertisement positioning). Additionally, the products may be arranged based on previously made business decisions or agreements. For example, a retailer may have an agreement with a distributor to more prominently advertise certain products.

g) Location sales (i.e. data ordered based on the individual store sales). POS data can be evaluated for location product sales. Higher velocity products represent local market demand, which may reflect a market trend, and therefore can be given a more prominent advertising position.

i) Aging inventory (i.e. data representing products going out of date within a defined period of time rendering them below market value or unsalable). Aging inventory needs to be moved out of inventory to reduce loss and therefore may be given a more prominent advertising position.

j) POS actual sales vs. promotions (i.e. having access to POS data from a plurality of retailers will allow evaluation of the sales performance of each item promoted).

k) Demographic & Psychographic data (i.e. data ordered based on target audience information). Ads are generated specifically for audience based on education, age, income, house ownership, patterns, profiles and history.

l) Consumer demand (i.e. data ordered based on current market conditions, demand and propensity to purchase). Ads are generated specifically based on the needs and desires of consumers in a specific market.

m) Analytics (i.e. data ordered based on market trends and predictive analysis). Ads are generated specifically for an audience based on aggregated and analyzed data.

n) Consumer education (i.e. data is ordered and provided based on need for information and education in a market). Ads are generated based on demand for information and education about a specific topic, desire or need in the market.

Comparisons can be made, for example, 30, 60, or 90 days prior to 30, 60, or 90 days after promotion to see impact. Products advertised receiving the highest sales impact may receive prominence when advertised in the future.

Combining actual retail product orders or retail sales with these ranking schemas will allow the system to put items into the request for an advertisement to be automatically generated and delivered. The combined instances of these categories and the prioritization of these categories can provide the weighted order for advertisement content. The categories of prioritization can also be ranked (e.g. products nearing their expiration data may be ranked higher than products having a higher profit margin). Thus, the system can create the advertisement taking multiple data categories into consideration.

In another embodiment, the system will automatically generate an advertisement, without manual interaction, based on levels of the preceding criteria being met, exceeded or falling below a predefined level. Products or services may be advertised independently or jointly with other products or services meeting the criteria. Automated ad development and delivery may also be triggered by time periods or other intervals, consumer interest, product orders, competitive information, promotional discounts, purchase price, inventory levels, and other business data, information, or conditions. Preferably, the advertiser will be able to choose their preferences on when the ads are created.

In another embodiment, the system will analyze data input into the system in combination with market analyses, product sales information, regional market conditions, local market activity, consumer purchasing behaviors as well as other trends and information, to determine which products or services to advertise and in which order to advertise the products. Intelligent and predictive analytics built into the system will analyze each instance of data input into the system and compare the data to historical, national, regional, local, consumer, corporate, distributor, vendor and other relevant data. Other current or historical market data, such as market trends, consumer buying habits, economic conditions, demographic information, and seasonal influences and patterns, will be analyzed in combination with each data instance. The concluding analysis will trigger the system to suggest, offer, or automatically place products and information, using the methodology provided herein, into an advertisement based on which individual products or product combinations provide the user with the greatest potential to influence purchases and generate sales and profit opportunities.

A main server may contain life-to-date (or life cycle) data for each entry. The main server database can be used for web-based reporting as well as the source for service queries. In addition, it may be a backup for data. The main server database can be backed up hourly, daily, weekly, in real time, or at another time interval to the hosting company's storage facilities, as well as being co-located at an alternate hosting site. Furthermore, in a preferred embodiment, a cloud database (e.g. Microsoft's Azure) can be utilized.

For a virtual store or smaller retail store requiring only one workstation functioning as a cash register and administrative reporting station, an embedded database can be used. When in the disconnected (e.g. from the Internet) state the application can rely solely on the embedded database. When the connection is restored, the application can synchronize the embedded database with the main server database.

Installations requiring more than one administrative or cash register position preferably use a local server instance running on a dedicated server. This server may be able to accommodate up to, for example, 10 GB of data and remain in synch with the main server database as long as Internet connectivity is present. The system may also include secure data transfer interfaces (e.g. web services) that can be exposed to the various components (e.g. applications) to facilitate sharing of information between the components.

For those multi-station installations that use laptops to act as mobile POS stations, each laptop preferably will contain an embedded database that will synch with the local database.

As decisions are made and transactions occur, such as products sold, pricing of the product, product discounts, products advertised and in which form they were advertised, which products sold were advertised, margin, website traffic, which advertisements were viewed online, which products were added to a shopping list, shopping cart, purchased, loyalty customers checked out (and their specific data), etc., they can be uploaded to the advertisement creator's data collection database. In the preferred embodiment, the information is “pushed” to the data collection database. For example, the retailers' POS system initiate uploads to the data collection database. Advertisements may be automatically constructed based on, for example, items purchased from a source, current industry promotions, based on inventory levels, based on retail transactions (POS), or based on future promotions.

Advertisements may also be created based on consumer information provided via loyalty programs, website profiles, online purchases or in-store transactions. Consumer profiles, desires, and needs can feed the advertising system to provide custom advertisements constructed automatically and directed specifically to the consumer. These advertisements may be staged to be received on a timed basis, may be linked, or may be directly distributed electronically via email, SMS or MMS text, mobile technology, social media, Twitter, or may be printed and distributed, or distributed by another method. Additionally, advertisements may be constructed and produced at check-out based on the purchases made by the consumer. The advertisements can be presented to the consumer in various formats, for example, emailed or otherwise electronically distributed.

In another embodiment, an advertiser will specify the advertising format that is desired. Preferably, the advertiser selects an advertising format from a plurality of advertising formats displayed on the computer screen. More preferably, the advertiser selects from a pull down menu of advertising formats. An advertising format establishes the type of advertisement that is desired. Examples include circulars that are distributed by hand to potential users, newspaper inserts that are distributed as part of a newspaper, direct mail advertisements that are mailed directly to potential users, newsletters that are distributed to existing clients in order to keep them informed, and banners. Advertising materials that may be generated using the present invention are not limited to these examples, but may include any kind of print, digital, electronic or other form of advertisement, including, but not limited to, post cards, price cards, shelf-talkers, coupons, video, audio, social media, newsletters, educational materials, posters, signage, flyers, run-of-press (ROP) or other newspaper advertisements, billboards, presentations, brochures, collateral materials, letterhead, business cards, pocket folders, display materials, reports, and other types of advertisements, literature, and printed materials.

Business rules may also be defined for, and applied to, each advertisement to control customization aspects based upon manufacturer relationships or their contributions to the cost of the advertisement. Also, product advertisement areas may be locked, or may be bounded, by a variety of criteria, including manufacturer, brand, category, product, price, etc.

The system maintains, in a memory storage device, a list of product references. In a preferred embodiment, the present invention includes a database of product references, which database can be readily accessed and regularly updated. The database may be organized such that each product reference is allocated a record, which includes an image (or a reference marker that associates an image with the product), and text (or other information) that describes one or more features of the product (for example, title, price, weight, etc.). Of course, the present invention contemplates that many other known means of organizing data and databases may be used to maintain a plurality of product references for purposes of this invention.

The present invention may also utilize multiple databases of product references. This is especially useful when the user is a local office of a national chain. For example, the present invention may use one database of product references for products that are advertised nationally, and a second database of product references for products that are advertised locally. This will permit an advertiser to participate in a national advertisement campaign, and yet permit the advertiser to add products that are important to a local clientele.

Pricing can be provided through the data source if applicable. Pricing may be displayed within an advertisement based on the database price, based on a mark-up of the database price controlled within the data source, based on suggested retail or sale pricing, based on historical sale price, or through the user interface.

In a preferred embodiment, the advertiser is provided with an opportunity to preview the advertisement as it will look when completed. One way to provide this opportunity is with a “preview” button or link which, upon clicking, will automatically display or print an image that looks like the final advertisement as it should be produced. The system may also electronically display a proof to be accepted before producing an advertisement. A proof may also be available in the “Archives” section of the program after rendering or processing the advertisement prior to production. A high resolution file may also be supplied electronically or physically.

How and where the proof or preview is generated depends upon the advertising format that is being used. For example, advertisements may be displayed electronically on a screen or other computing devise. For a black and white advertisement, the proof may be generated at a printer operated by the advertiser (on the premises of the advertiser). If a multi-colored glossy circular is desired, the proof may be generated by a professional printer that is located remotely relative to the advertiser. To generate a preview, the present invention may transmit electronically the advertisement to a commercial printer, who may process and create an electronic preview or print a hard-copy proof of the final advertisement.

In a preferred embodiment, the system and the method of the present invention may provide the advertiser with the opportunity to further customize the advertisement. For example, by adding or deleting product references, by adding or deleting text, images, or details, by rearranging portions of the advertisement, by changing the format of the advertisement, and by changing the template of the advertisement. When the advertiser selects the advertising format, or the template, or the product reference, the advertiser may customize the advertisement by inserting items such as images, text, logos, etc. These items may also be in a database, or may be imported from another program, or may be created by the advertiser at that time. Preferably, all items have textual title or description that may be arranged in a layout. Items with an associated image would preferably contain a transparent background unless they are a lifestyle image or a square cut and have an image that encompasses the allowable area. This allows an item with a transparent background to be placed over an item for another product but the product will not be completely hidden. For example, a store name and a price may be in red, on a transparent background, and placed over a product reference showing a yellow shirt or towel. This allows the advertiser to place images anywhere on a page, with the colored background of the advertisement surrounding the image, so that the advertiser is no longer constrained to place an image into a white box. This allows the information to be displayed along with the product without requiring that the product space be reduced to make space for the information, and without the background of the information obscuring the product. This improves the aesthetics of the advertisements and allows for a more finished appearance, i.e., a more retail look. The system also allows the advertiser to overlap advertisement elements, to create layers, and to dynamically direct the placement of advertisement elements anywhere in the advertisement.

The advertiser may review the preview to confirm that the draft advertisement as created using the present invention is acceptable in terms of content, design, quality, etc. If the advertiser approves of the preview, the final advertisements may be downloaded, transferred, posted electronically, or printed preferably in accordance with any printing specification that may have been provided by the advertiser and/or generated by the program. In addition, the invention may offer the user an automatic checking feature of prices, quantities, inventory availability (e.g. in store availability or availability from distributor or manufacturer facilities) or other options (e.g. size, color, composition) against preset or predetermined parameters.

It is contemplated that the present invention may be implemented in a manner that provides an account for an advertiser to access, and further that the account provides access to a memory storage device where the advertiser may store data and other information relevant and/or unique to the advertiser. For example, a host computer that may be accessed through an Internet connection may store product references, templates, and other custom information for an advertiser, such that when an advertiser logs into its account, the information is readily available. This approach will also permit certain additional convenience features. For example, an advertiser's files, data, orders, and other information may be automatically saved for the benefit of the advertiser. Further, saving can be set up to occur automatically at periodic intervals, as well as automatically upon the termination of an account session (e.g., upon log-off). The advertiser may also be presented upon a subsequent login, the option of editing a prior session's advertisement or creating a new advertisement. Automatic saving features have the advantage of significantly reducing the risk of lost data, which consequently helps to reduce the time associated with creating subsequent advertisements.

In one embodiment of the present invention, the methods and systems may provide delivery options. For example, an advertiser may chose from a plurality of delivery options that include a) electronic mail delivery to a list of recipients, b) electronic linking or posting to a website, c) electronic text to a mobile device, d) a direct mailing to potential customers whose names and addresses are provided by the advertiser, e) a direct shipping to a newspaper publisher, f) a direct shipping to the advertiser at one or multiple locations, g) electronic file transfer to a commercial printer, h) direct file download, i) delivery though mobile platforms, j) posting to social media sites, k) linking to a hosted website, and l) posting to a website. When a direct mailing is selected, the advertiser may preferably provide a data file of names and addresses of persons who will receive hard copies or electronic direct mailings. The data file may be provided, for example, via the Internet or a storage media (e.g. hard drives, zip disks, CDs, diskettes).

Automated advertisements may be scheduled for production based on data provided. For example, 6 months of pre-booked orders may be pre-loaded in advance of a promotion and scheduled through data to automatically produce advertisements on the first day of each month. The system will then produce and deliver custom advertisements per the schedule specified.

The advertisements may be constructed as far in advance of a promotion, sale, or event as the data is made available. Advertisements may be constructed for an unlimited number of locations within one data source. In one embodiment of the present invention, the methods and systems may provide print schedules. Print schedules permit an advertiser to plan the logistics of meeting a particular advertising goal. For example, a print schedule may include two dates: 1) a distribution date—which is the date by which an advertiser may wish to have its advertisements distributed; and 2) a publication deadline—which is a date by which the proposed advertisement should be completed in order to meet the distribution date. These dates are typically set by the program administrator based upon the requirements of the advertiser's business and the schedules of the commercial printers that the advertiser will be using in the printing process. In another embodiment these dates may also be set by an advertiser or system administrator through an interface. In another embodiment, these dates are provided through data and automated within the system.

In one embodiment, an advertiser may be presented with a plurality of schedules from which the advertiser may choose. In another embodiment, the advertiser may include a distribution date with the uploaded data, and the present invention may calculate the publication date based upon a pre-determined formula (for example, a particular printer requires two week's notice to print a job).

The system may also create reports based upon all activities within the system including types of advertisements produced, content of the advertisements, advertisements developed based on consumer needs, and other reports.

The following examples illustrate embodiments of the invention, but should not be viewed as limiting the scope of the invention.

### EXAMPLES

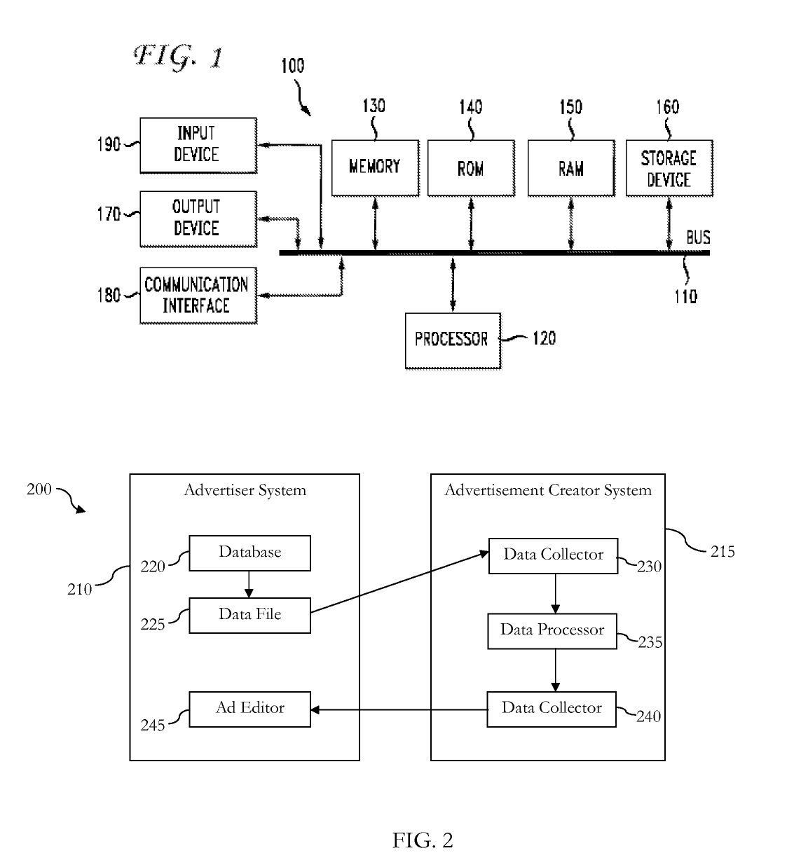

FIG. 2 depicts an embodiment of a preferred system 200 of the invention. System 200 is divided into two parts: the advertiser system 210 and the advertisement creator system 215. On the advertiser system 210, the advertiser maintains a database 220 of data. The data may include, but is not limited to, products to be advertised, price of the products, dates of sales, dates for advertisement publication, mark-ups on prices, priority rankings of products, and advertisement codes (e.g. codes for type of advertisement, templates for advertisement, and characteristics for advertisements). In certain embodiments, the advertisement creator system 215 can store the product reference assets (e.g. product images, descriptions, or prices) and the advertiser system can store codes to point to the assets. When the advertiser is ready to order an advertisement or a set of advertisements, the advertiser compiles the data for the advertisement(s) into a data file 225 for transmittal to the advertisement creator or inputs the data directly. The data file can be XML, CSV, Access, Excel, a POS system, or another data compiling system. Transmittal can be through an Internet interface, FTP site, direct system interface, or another uploading system. Additionally, the advertiser system can upload to the advertisement creator system continuously, at predetermined intervals, randomly, or at another time intervals.

In another preferred embodiment, an interface provides the option of ordering printed copies of an advertisement from one or more sources.

In another preferred embodiment, an interface provides the option of researching, requesting, ordering and managing direct mail, newspaper insert and other advertisement distribution services. These services include zip code mapping, selecting a subset of households within a geographical location delivery region, accessing and analyzing demographic information, viewing pricing and delivery options such as solo, shared, marriage and other program options, viewing and selecting frequency, promotions, discounts, placing the direct mail order and receiving a confirmation.

The advertisement creator system 215 receives and stores the data file 225 in a data collector 230. The advertisement creator system 215 interprets the data in a data processor 235. If the advertiser indicates (either directly or within the data) that an advertisement is desired, the data processor 235 compiles the necessary data and provides the data to an advertisement creation processor 240. If no advertisement is currently desired, the data processor 235 stores the data in the data collector 230 for future advertisements. The advertisement creation processor 240 automatically completes the advertisement based on the data provided by the advertiser system 210. Upon completion of the advertisement, the advertisement creation processor 240 transmits the completed advertisement to the advertiser system 210. Transmittal can be through an Internet interface, FTP site, direct system interface, or another uploading system. The advertiser system 210 provides the advertiser the opportunity to review or edit the advertisement in an advertisement editor 245. The advertiser may be able to edit the entire advertisement or just parts of the advertisement. The advertisement creator system 215 may send the advertiser a message (e.g. an email or text message) to alert the advertiser that the advertisement is completed and ready for review. Once the advertisement is to the advertiser's specifications, the advertisement can be transmitted to a printer for completion, transmitted electronically, or otherwise distributed as desired by the advertiser.

While advertiser system 210 and advertisement creator 215 are described as two separate systems, they can be one system. Furthermore, each system can run on multiple processors or one processor. The systems can be located remotely from each other or in the same location.

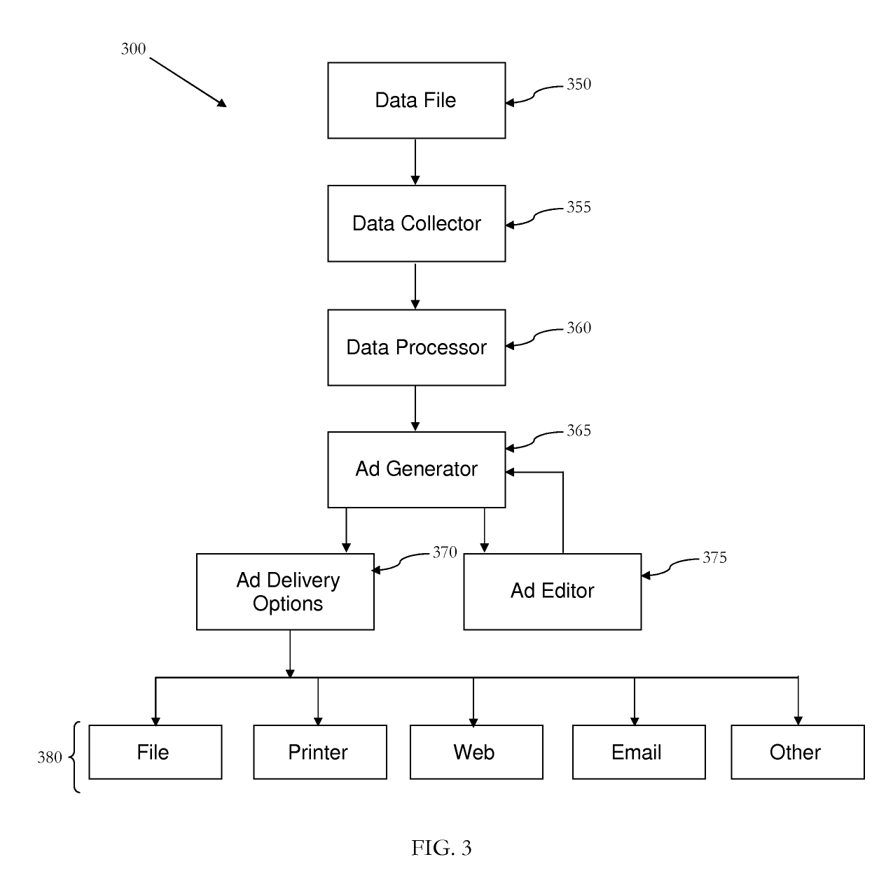

FIG. 3 depicts a flow chart of a method 300 of creating an advertisement. An advertiser starts the process by creating a data file 350, as described herein, the data file preferably contains products to be advertised, price of the products, dates of sales, dates for advertisement publication, mark-ups on prices, priority rankings of products, advertisement codes (e.g. codes for type of advertisement, templates for advertisement, and characteristics for advertisements), product reference assets (e.g. product images, descriptions, or prices), and/or codes to point to the assets. The data file is preferably XML, CSV, Access, Excel, a POS system file, or another data file.

The data file is preferably transmitted to a data collector 355, where the file is stored and can be updated as desired by the advertiser. At the time to create an advertisement, a data processor 360 obtains the data from the data collector 355 and parses the data. The advertisements can be generated at regular intervals, under specific conditions chosen by the advertiser (e.g. when there is a surplus of a product, when a products expiration date is approaching, or when a new model of a product arrives), as desired by the advertiser, and/or at other times. In other embodiments, a single advertisement is automatically created and delivered to a specific customer based on purchasing information or product inquiry by the customer. Based on the parsed data, the ad generator 365 determines what type of advertisement to create and what resources (e.g. text, images, colors, and prices) to include in the advertisement.

Once the ad generator 365 generates the advertisement, the advertiser is presented with a preview of the advertisement for approval and, optionally, to edit the advertisement using an ad editor 375. The advertiser may be able to edit the entire advertisement or only a portion of the advertisement. Once the advertiser is satisfied with the advertisement, the advertiser will be able to select the advertisements delivery options 370. For example the delivery options 380 may include saving the advertisement to file, sending the advertisement to a printer, publishing the advertisement on a website, emailing the advertisement to a list of email address, or another disbursement method. In another embodiment of the advertiser is not presented with a preview of the advertisement and, instead, the advertisement is disseminated automatically without the advertiser's approval. Additionally, the content of an advertisement may be used to automatically update website keywords for search engine optimization.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising” includes the terms “consisting of” and “consisting essentially of,” and the terms comprising, including, and containing are not intended to be limiting.

1. A advertisement creation system, comprising:
a processor;
a first interface executing on the processor that accepts transactional data;
a data compiler executing on the processor that processes the transactional data and determines an advertisement creation schedule based on the processed data;
an advertisement creator executing on the processor that automatically creates an advertisement based on a set of rules and the processed data; and
an output device to output the advertisement.

2. The advertisement creation system of claim 1, wherein the first advertiser interface accepts a data file directly into the system uploaded one of manually by the advertiser or automatically.

3. The advertisement creation system of claim 1, wherein a second advertiser interface executing on the processor obtains edits to the advertisement from the advertiser.

4. The advertisement creation system of claim 1, wherein a third advertiser interface executing on the processor presents the advertiser with a preview of the advertisement and accepts a selection of a file type for output.

5. The advertisement creation system of claim 4, wherein the file output type is one of an electronic or print-ready, a high-resolution file, a low resolution file, an email, an html file, an image, a website, a SMS or MMS text, a common data file, a POS data file, a report, a graphic, an audio file, or a video file.

6. The advertisement creation system of claim 5, wherein the file output is automatically formatted for a commercial printer, desktop printer, social media, mobile platforms, audio player, video player, Smartphone, Tablet, laptop, website, email, or text message.

7. The advertisement creation system of claim 1, wherein the transactional data is uploaded as at least one of an XML file, a CSV file, an Access file, an Excel file, or a POS system file.

8. The advertisement creation system of claim 1, wherein the transactional data comprises at least one of an advertisement creation schedule, a product or service to be advertised, title, educational information, product data, ingredients, item number, description, item number, SKU, price, dates of sale, date for advertisement publication, mark-up on price, margin, priority ranking of products, advertisement codes, and combinations thereof.

9. The advertisement creation system of claim 1, wherein the set of rules dictate at least one of the priority of the products to be advertised based on business criteria, layout of the ad, arrangement, creative treatment, type of ad, file output, and delivery method.

10. The advertisement creation system of claim 10, wherein the business criteria are at least one of sales volume, velocity, price, margin, discount, inventory levels, inventory age, shelf life, product life-cycle, sales history, promotions, rebates, distribution, availability, competition, trends, marketing, consumer interest, consumer demand, socio-economic, demographic or psychographic data, purchasing propensity, expiration date, regional and seasonal influences, and combinations thereof.

11. The advertisement creation system of claim 10, wherein the data compiler determines the advertisement creation schedule based on the business criteria reaching a specified level.

12. The advertisement creation system of claim 1, wherein a data source is linked to the system for automatic and scheduled advertisement creation.

13. The advertisement creation system of claim 1, wherein the advertiser is notified of a created advertisement through one of an email, system alert, text, or an electronic notification.

14. The advertisement creation system of claim 1, wherein, upon completion, an ad is automatically delivered to an advertiser-specified destination, wherein the advertiser-specified destination is at least one of a commercial printer, email distribution list, website, SMS text recipients, website, social media, intranet, extranet, and direct mail service.

15. The advertisement creation system of claim 1, wherein an order interface obtains printing, direct mail services, newspaper insertion, audience information, recipient information, and delivery options from the data or directly from the advertiser via an interface.

16. The advertisement creation system of claim 1, wherein the advertisement is automatically posted or linked to websites.

17. The advertisement creation system of claim 1, wherein the system automatically updates website keywords for search engine optimization based on the content of an advertisement.

18. The advertisement creation system of claim 1, wherein multiple advertisements are created automatically from the transactional data and are automatically provided to a selected audience.

19. The advertisement creation system of claim 1, wherein a single advertisement is automatically created and delivered to a customer based on purchasing information or product inquiry.

20. The advertisement creation system of claim 1, wherein the advertisement is automatically posted to social media services.

21. The advertisement creation system of claim 18, wherein the single advertisement is delivered to the customer via at least one of email and text message.

22. The advertisement creation system of claim 18, wherein the single advertisement is delivered at a determined time after the consumer inquiry.

23. The advertisement creation system of claim 1, wherein the completed advertisement data is made available as a data file to export into a POS system, mainframe, or common data program.

24. The advertisement creation system of claim 1, wherein the transactional data is gathered, processed, and analyzed by the system and updates the set of rules for future automatically generated advertisements.

25. The advertisement creation system of claim 1, wherein the system schedules advertisement creation based on a schedule contained within the transactional data or initiates the creation of an advertisement in the absence of a schedule contained within the transactional data.

26. A method of creating an advertisement, the method comprises the steps of a computer:
obtaining transactional data;
processing the transactional data;
determining an advertisement creation schedule based on the compiled transactional data;
applying the compiled transactional data to a set of rules to determine advertisement priorities;
automatically creating an advertisement based on the advertisement priorities; and
outputting the advertisement to an output device.

27. The method of claim 26, wherein a data file is uploaded directly to the computer one of manually by the advertiser or automatically.

28. The method of claim 26, further comprising obtaining edits to the advertisement from the advertiser.

29. The method of claim 26, further comprising presenting the advertiser with a preview of the advertisement and accepting a selection of a file type for output.

30. The method of claim 29, wherein the file output type is one of an electronic or print-ready, a high-resolution file, a low resolution file, an email, an html file, an image, a website, a SMS or MMS text, a common data file, a POS data file, a report, a graphic, an audio file, or a video file.

31. The method of claim 30, wherein the file output is automatically formatted for a commercial printer, desktop printer, social media, mobile platforms, audio player, video player, Smartphone, Tablet, laptop, website, email, or text message.

32. The method of claim 26, wherein the transactional data is uploaded as at least one of an XML file, a CSV file, an Access file, an Excel file, or a POS system file.

33. The method of claim 26, wherein the transactional data comprises at least one of an advertisement creation schedule, a product or service to be advertised, title, educational information, product data, ingredients, item number, description, item number, SKU, price, dates of sale, date for advertisement publication, mark-up on price, margin, priority ranking of products, advertisement codes, and combinations thereof.

34. The method of claim 26, wherein the set of rules dictate at least one of the priority of the products to be advertised based on business criteria, layout of the ad, arrangement, creative treatment, type of ad, file output, and delivery method.

35. The method of claim 34, wherein the business criteria are at least one of sales volume, velocity, price, margin, discount, inventory levels, inventory age, shelf life, product life-cycle, sales history, promotions, rebates, distribution, availability, competition, trends, marketing, consumer interest, consumer demand, socio-economic, demographic or psychographic data, purchasing propensity, expiration date, regional and seasonal influences, and combinations thereof.

36. The method of claim 34, further comprising determining the advertisement creation schedule based on the business criteria reaching a specified level.

37. The method of claim 26, wherein a data source is linked to the system for automatic and scheduled advertisement creation.

38. The method of claim 26, further comprising notifying the advertiser of a created advertisement through one of an email, system alert, text, or an electronic notification.

39. The method of claim 26, wherein, upon completion, automatically delivering the advertisement to an advertiser-specified destination, wherein the advertiser-specified destination is at least one of a commercial printer, email distribution list, website, SMS text recipients, website, social media, intranet, extranet, and direct mail service.

40. The method of claim 26, further comprising obtaining printing, direct mail services, newspaper insertion, audience information, recipient information, and delivery options from the data or directly from the advertiser via an interface.

41. The method of claim 26, further comprising automatically posting or linking the advertisement to websites.

42. The method of claim 26, further comprising automatically updating website keywords for search engine optimization based on the content of an advertisement.

43. The method of claim 26, wherein multiple advertisements are created automatically from the transactional data and are automatically provided to a selected audience.

44. The method of claim 26, wherein a single advertisement is automatically created and delivered to a customer based on purchasing information or product inquiry.

45. The method of claim 26, wherein the advertisement is automatically posted to social media services.

46. The method of claim 45, wherein the single advertisement is delivered to the customer via at least one of email and text message.

47. The method of claim 45, wherein the single advertisement is delivered at a determined time after the consumer inquiry.

48. The method of claim 26, further comprising making the completed advertisement data available as a data file to export into a POS system, mainframe, or common data program.

49. The method of claim 26, wherein the transactional data is gathered, processed, and analyzed by the system and updates the set of rules for future automatically generated advertisements.

50. The method of claim 26, further comprising scheduling advertisement creation based on a schedule contained within the transactional data or initiating the creation of an advertisement in the absence of a schedule contained within the transactional data.
